(19) United States
(12) Patent Application Publication
(10) Pub. No.: US 2005/0252946 A1
(43) Pub. Date: Nov. 17, 2005

(54) Protection module for protecting objects against threats, especially against hollow loads

(76) Inventors: Harald Westermann, Kassel (DE); Peter Gall, Koblenz (DE)

Correspondence Address: ROBERT W. BECKER & ASSOCIATES, 707 HIGHWAY 66 EAST, SUITE B, TIJERAS, NM, 87059, US

(21) Appl. No.: 10/538,683

(22) PCT Filed: Dec. 5, 2003
(86) PCT No.: PCT/DE03/04010

§ 371 Date: Jul. 13, 2005

(30) Foreign Application Priority Data
Dec. 12, 2002 (DE) 102579423

(51) Int. Cl. B23K 1/00

(52) U.S. Cl. 228/101

(57) ABSTRACT

A protection module for protecting objects against threats, especially hollow loads. The protection module is made of a material or contains a material which is configured as a three-dimensional metal grid structure or open-pored metal foam which is 4-40 ppi thick. A solid or liquid material can be introduced into the pores of said material. The protection module can be structured in such a way that a sequence of layers is arranged inside a housing (2′,3′,4′,5′), said layer sequence containing layers (7,9) of material embodied in the form of a three-dimensional metal grid structure or open pored metal foam, and layers (6,8,10) of air.

The present invention relates to a protection module for protecting objects against threats, in particular against hollow loads.

Already different types of protective structural systems are used for protecting objects, for example combat tanks, from hollow loads, which generally are formed in a sandwich structure and can comprise different materials. The basic operating principle of these protective structures is to fan out the copper barbs of a hollow load as widely as possible, by means of the most common material transitions, so that its penetration effect is significantly reduced.

Such protective structures for protection against hollow loads are already used on different military vehicles.

The protective structures developed and used until now against hollow loads, however, have relatively few material transitions and have high coating weights per unit area.

The invention is based on the object of producing a protective module for protecting objects against threats, in particular against hollow loads, which has an extremely low coating weight per unit area and with which it is possible to achieve a substantial fanning out of the typical copper barbs of hollow loads.

This object is solved according to the present invention, in that the protection module is made from a material, or contains a material, which is formed as a three-dimensional metal grid structure or open-pored metal foam with a density of 5 to 40 ppi (pores per inch). In this regard, it is advantageous if the density of the three-dimensional metal grid or the open-pored metal foam is 10 to 20 ppi (pores per inch).

The core idea of the present invention comprises using a material for constructing a protection module which is known, but which was used until now for a completely different purpose. It is a material which is designated generally as a three-dimensional metal grid structure or also as an open-pored metal foam. Such materials are known, and their manufacture is described in DE 199 39 155 A1 and DE 199 46 528 A1, for example. The material was used until now, for example, for construction of heat exchangers or also tank protection.

If one uses this material as a base material for construction of a protection module in lightweight construction, one achieves a substantially large number of material transitions between the base material and air or a filler applied in this open-pored base material by means of the specialized construction of this material.

In order to achieve the most effective material transitions and a minimal coating weight per unit area, the density of the metal foam formed as a metal grid structure or open-pored metal foam should lie between 5 and 40 ppi, preferably between 10 and 20 ppi (ppi=pores per inch).

In principle, all metals can be used for making this type of material. In particular, metals that can be cast well, such as iron or steel, aluminum, silver, gold, and so on, are suitable.

It is particularly advantageous to apply a filler material in the hollow spaces of the material formed as a metal grid structure or open-pored metal foam. This filler material can be a solid material, for example a ceramic material based on SiO or a mineral or a metal; however, a liquid material, such as water or glycol, for example, also can be used.

A metal grid structure or an open-pored metal foam made from aluminum can serve as a typical base material, which is coated externally with steel.

For the practical use as a protection module, it is advantageous when the material formed as a metal grid structure or open-pored metal foam is introduced into a housing, whereby this housing can have attachment elements for attaching the protection module to an object, for example to a combat vehicle. Such a housing can be made from thin armor steel sheets, into which this material is introduced, if necessary with additional intermediate air spaces. This thickness of the material layer or the protection module that is used is based on the structure of the protection module and the anticipated threat. It can be 40 to 100 mm, for example; however, it also can be thinner or thicker.

Next, exemplary embodiments for a protection module according to the present invention will be explained in greater detail with reference to the accompanying figures.

In the figures:

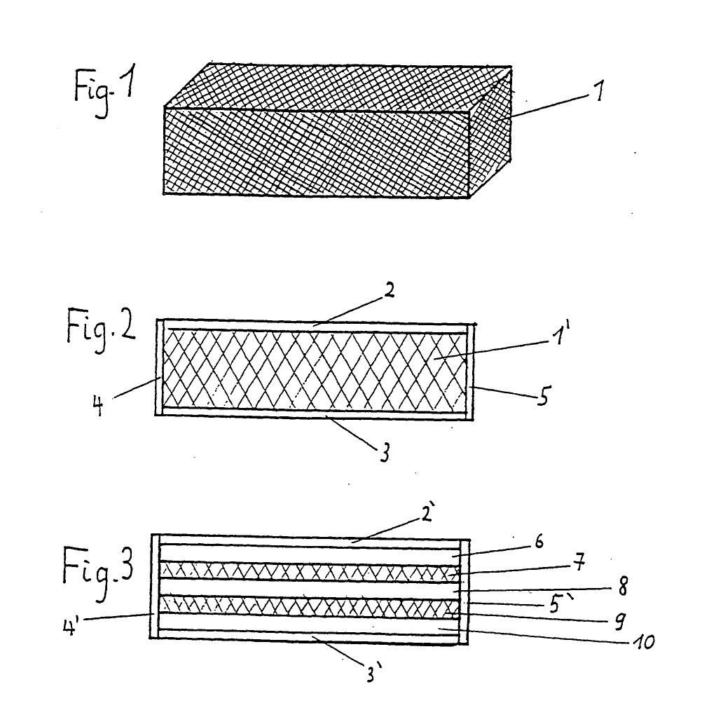

FIG. 1 shows a material piece comprising a three-dimensional metal grid structure or an open-pored metal foam in a perspective representation;

FIG. 2 shows a protection module made with a material piece analogous to that of FIG. 1 in a longitudinal section;

FIG. 3 shows a protection module made in a sandwich-type structure in a representation analogous to that of FIG. 2.

FIG. 1 shows a material piece 1, which is formed as an areal, metal grid structure or open-pored metal foam and is made according to known methods. The crosshatching used in FIG. 1 designates merely symbolically the structure of the material piece 1. The material can be an open-pored aluminum foam, for example, with cross-sectional surfaces arranged in irregular statistic apportionment.

FIG. 2 shows a protection module with walls 2, 3, 4, and 5, for example of steel, which is filled with a material 1′, which is formed in the described manner as an areal, metal grid structure or open-pored metal foam.

FIG. 3 shows another embodiment of a protection module with walls 2′, 3′, 4′, and 5′, for example of steel, which is made in a sandwich-type manner, that is, for example, in the sequence front sheet 2′—air 6—open-pored metal foam 7—air 8—open-pored metal foam 9—air 10—connection endplate 3′.

Of course, a plurality of arrangements of layering is possible. Likewise, different materials for making the layers can be used, and instead of the intermediate air spaces, fillers made from a ceramic or mineral material or a liquid can be used, for example.

1-13. (canceled)

14. A protection module for protecting objects against threats in the form of hollow loads, comprising:
a material formed as a three-dimensional metal grid structure or open-pored metal foam having a density of 5 to 40 ppi (pores per inch).

15. The protection module according to claim 14, wherein the density of the three-dimensional metal grid structure or of the open-pored metal foam is 10 to 20 ppi (pore per inch).

16. The protection module according to claim 14, wherein the three-dimensional metal grid structure has hollow spaces and the open-pored metal foam has pores, and wherein a filler material is introduced into the hollow spaces or pores.

17. The protection module according to claim 16, wherein the filler material is a solid material.

18. The protection module according to claim 17, wherein the filler material is a ceramic material.

19. The protection module according to claim 17, &herein the filler material is a mineral material.

20. The protection material according to claim 16, wherein the filler material is a liquid material.

21. The protection module according to claim 14, &herein the material formed as a three-dimensional metal grid structure or open-pored metal foam is introduced into a housing.

22. The protection module according to claim 21, Wherein the housing has attachment elements for attaching the protection module to an object.

23. The protection module according to claim 14, wherein the material formed as a three-dimensional metal grid structure or open-pored metal foam is introduced in at least one layer into a protection module formed as a sandwich plate.

24. The protection module according to claim 21, wherein intermediate air spaces are disposed in the protection module between layers made from the material formed as a three-dimensional metal grid structure or open-pored metal foam.

25. The protection module according to claim 21, wherein the material formed as a three-dimensional metal grid structure or open-pored metal foam is coated with a coating material on at least one side.

26. The protection module according to claim 25, wherein the coating material is a metal.

27. The protection module according to claim 25, wherein the coating material comprises a different material than the material formed as a three-dimensional metal grid structure or open-pored metal foam.
